(19) United States
(12) Patent Application Publication
(10) Pub. No.: US 2020/0204783 A1
(43) Pub. Date: Jun. 25, 2020

(54) METHOD AND DEVICE FOR PROCESSING IMAGE DATA

(71) Applicant: Goertek Inc., Weifang City, Shandong (CN)

(72) Inventors: Tianrong DAI, Weifang City (CN); Yuge ZHU, Weifang City (CN); Dachuan ZHAO, Weifang City (CN); Xiang CHEN, Weifang City (CN)

(73) Assignee: Goertek Inc., Weifang City, Shandong (CN)

(21) Appl. No.: 16/094,728

(22) PCT Filed: May 18, 2018
(86) PCT No.: PCT/CN2018/087507

§ 371 Date: Oct. 18, 2018

(30) Foreign Application Priority Data
Jul. 14, 2017 (CN) 201710575724.2

(51) Int. Cl. H04N 13/161; H04N 13/194; H04N 13/332

(52) U.S. Cl. CPC H04N 13/161; H04N 2013/0074; H04N 13/332; H04N 13/194

(57) ABSTRACT

A method and device for processing image data are disclosed. In the method, a host of a virtual reality device calculates the difference between acquired left eye image data frame and right eye image data frame to obtain difference information, conducts compressed encoding on the difference information, and then sends the difference encoded information and the left eye or right eye image data frame to a head-mounted display; the head-mounted display receives the difference encoded information and the left eye or right eye image data frame, decompresses the difference encoded information, and obtains the corresponding right eye or left eye image data frame by using the difference information and the received left eye or right eye image data frame, to display the left eye image data frame and the right eye image data frame

### TECHNICAL FIELD

The present disclosure relates to the technical field of data transmission, and particularly relates to a method and device for processing image data.

### BACKGROUND

Virtual reality (VR) devices usually comprise a host and a display which are connected in a wired or wireless manner. Along with the improvement of the standard of living, people are pursuing the visual experience of large display screen and large field angle. The displays of the VRs on the market usually have a large field of vision (FOV), for example, 120° or 150°, so when the host transmits a large volume of data such as image data and video data, there will be a large delay.

For example, regarding a single eye 1K (1200*1080) display screen of a display refresh rate of 90 Hz, if 1 pixel point is expressed by 24 bit, image data of 1200*1080*2 (two eyes) *90*24=5.6 Gbit/s must be transmitted. The transmission of such a large volume of image data will occupy a large bandwidth. When the host and the display of the VR transmit data wirelessly, the data must be compressed and decompressed, which will result in a very large delay, and the delay is a key factor that affects the VR experience.

### SUMMARY

The present disclosure provides a method and device for processing image data, to solve the problem of the large delay in the data transmission between the host and the display of a VR.

According to an aspect of the present disclosure, the present disclosure provides a method for processing image data, applied to a host of a virtual reality device, wherein the method comprises:

acquiring a left eye image data frame and a corresponding right eye image data frame that are to be transmitted, and calculating a difference between the acquired left eye image data frame and corresponding right eye image data frame, to obtain difference information between the two eye image data frames;

conducting compressed encoding on the difference information by using a preset encoding rule, to obtain compressed difference encoded information; and

sending the difference encoded information and the left eye image data frame to a head-mounted display of the virtual reality device; or, sending the difference encoded information and the right eye image data frame to a head-mounted display of the virtual reality device.

The present disclosure further provides a method for processing image data, applied to a head-mounted display of a virtual reality device, wherein the method comprises:

receiving difference encoded information and a left eye image data frame that are sent by a host of the virtual reality device, or, receiving difference encoded information and a right eye image data frame that are sent by a host of the virtual reality device; wherein the difference encoded information is obtained by conducting compressed encoding by using a preset encoding rule on difference information between the left eye image data frame and the right eye image data frame that are to be transmitted;

decompressing the difference encoded information according to a preset decoding rule, to obtain the difference information;

obtaining the corresponding right eye image data frame according to the difference information and the received left eye image data frame, or, obtaining the corresponding left eye image data frame according to the difference information and the received right eye image data frame; and

displaying the left eye image data frame and the right eye image data frame.

According to another aspect of the present disclosure, the present disclosure provides a device for processing image data, applied to a host of a virtual reality device, wherein the device comprises:

a difference acquiring unit, configured to acquire a left eye image data frame and a corresponding right eye image data frame that are to be transmitted, and calculate a difference between the acquired left eye image data frame and corresponding right eye image data frame, to obtain difference information between the two eye image data frames;

an encoding unit, configured to conduct compressed encoding on the difference information by using a preset encoding rule, to obtain compressed difference encoded information; and

a sending unit, configured to send the difference encoded information and the left eye image data frame to a head-mounted display of the virtual reality device; or, send the difference encoded information and the right eye image data frame to a head-mounted display of the virtual reality device.

The present disclosure further provides a device for processing image data, applied to a head-mounted display of a virtual reality device, wherein the device comprises:

a receiving unit, configured to receive difference encoded information and a left eye image data frame that are sent by a host of the virtual reality device, or, receive difference encoded information and a right eye image data frame that are sent by a host of the virtual reality device; wherein the difference encoded information is obtained by conducting compressed encoding by using a preset encoding rule on difference information between the left eye image data frame and the right eye image data frame that are to be transmitted;

a decoding unit, configured to decompress the difference encoded information according to a preset decoding rule, to obtain the difference information;

a calculating unit, configured to obtain the corresponding right eye image data frame according to the difference information and the received left eye image data frame, or, obtain the corresponding left eye image data frame according to the difference information and the received right eye image data frame; and

a display unit, configured to display the left eye image data frame and the right eye image data frame.

According to still another aspect of the present disclosure, the present disclosure provides a device for processing image data, applied to a host of a virtual reality device, wherein the device comprises a machine-readable storage medium and a processor that are communicatively connected by an internal bus, the machine-readable storage medium stores a computer program executable by the processor, and when executed by the processor the computer program implements the steps of the above method.

The present disclosure further provides a device for processing image data, applied to a head-mounted display of a virtual reality device, wherein the device comprises a machine-readable storage medium and a processor that are communicatively connected by an internal bus, the machine-readable storage medium stores a computer program executable by the processor, and when executed by the processor the computer program implements the steps of the above method.

The advantageous effects of the present disclosure are as follows. In the present disclosure, the host of the virtual reality device calculates the difference between the left eye image data frame and the corresponding right eye image data frame that are to be transmitted, to obtain difference information between the two eye image data frames. The method does not need to conduct inter-frame redundant information movement estimation of high complexity, and can obtain the difference information between the two eye image data frames by using simple subtraction calculations. By conducting compressed encoding on the difference information by using simple encoding rules, the host only needs to transmit the difference encoded information and the image data frame of one eye, which reduces the bandwidth occupied by the transmission of image data, and further reduces the delay. In the present disclosure, the head-mounted display decodes the difference encoded information sent by the host to obtain the difference information, can construct the other eye image data frame by conducting simple addition operations with respect to the difference information and the received left eye image data frame, and can output and display the image data after the image data frame is completely constructed. The head-mounted display only needs to conduct simple decoding processing and addition operation to the received data, so the calculating complexity is low, and the required processing duration is very short. Therefore, the present disclosure can reduce the delay of the data display, and improve the user experience.

### BRIEF DESCRIPTION OF DRAWINGS

In order to more clearly illustrate the technical solutions of the present disclosure or the prior art, the drawings used in the embodiments will be briefly described below. Apparently, the drawings described below are merely examples of the present disclosure, and a person skilled in the art can obtain other drawings according to these drawings without paying creative work.

FIG. 1 is a flow chart of a method for processing image data applied to a sending end of a host according to an embodiment of the present disclosure;

FIG. 2 is a flow chart of a method for processing image data applied to a head-mounted display according to an embodiment of the present disclosure;

FIG. 3 is a functional block diagram of a device for processing image data applied to a sending end of a host according to an embodiment of the present disclosure;

FIG. 4 is a functional block diagram of a device for processing image data applied to a head-mounted display according to an embodiment of the present disclosure;

FIG. 5 is a structural block diagram of a device for processing image data applied to a sending end of a host according to an embodiment of the present disclosure; and

FIG. 6 is a structural block diagram of a device for processing image data applied to a head-mounted display according to an embodiment of the present disclosure.

### DETAILED DESCRIPTION

In order to make the objects, technical solutions and advantages of the present disclosure clearer, the embodiments of the present disclosure will be described below in detail in conjunction with the drawings. It should be noted that, the embodiments described below are merely some rather than all embodiments of the present disclosure. All other embodiments that are obtained on the basis of the embodiments of the present disclosure by a person skilled in the art without paying creative work shall fall within the protection scope of the present disclosure.

Inter-frame prediction is a common technique in video compression algorithm, which uses inter-frame redundant information of two adjacent frames in the same video sequence in a timeline to conduct movement estimation, and then conducts compression by using compressed encoding. However, for virtual reality devices, system delay is a very important indicator, and typical video compression algorithms will generate nonnegligible delay due to the high calculation complexity. In view of the above, the present disclosure provides a method for processing image data.

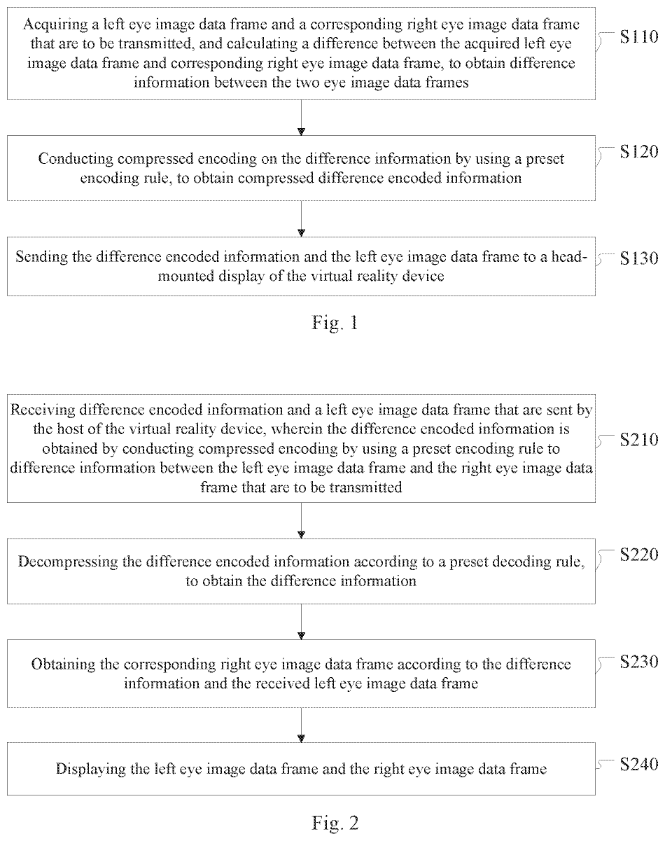

FIG. 1 is a flow chart of a method for processing image data applied to a sending end of a host according to an embodiment of the present disclosure. The processing method is applied to the host of a virtual reality device, and is particularly suitable for a host that conducts data transmission with a head-mounted display wirelessly.

As shown in FIG. 1, the method for processing image data of the present embodiment comprises:

S110, acquiring a left eye image data frame and a corresponding right eye image data frame that are to be transmitted, and calculating a difference between the acquired left eye image data frame and corresponding right eye image data frame, to obtain difference information between the two eye image data frames.

Exemplarily, the present disclosure may calculate the difference between the corresponding pixel values, such as RGB values, in the left eye image data frame and the right eye image data frame, to obtain difference information between the two eye image data frames.

S120, conducting compressed encoding on the difference information by using a preset encoding rule, to obtain compressed difference encoded information.

The difference information obtained by calculating the difference of the left and right eye image data frames is mainly close shot difference information between the two eye image data. In order to reduce the bandwidth occupied by the transmission process of image data, simpler compressed encoding methods such as run-length encoding or entropy encoding rules may be utilized to conduct compressed encoding on the difference information, to quickly compress and decompress the difference information, so that the delay generated by the compressing and decompressing processes can be neglected.

S130, sending the difference encoded information and the left eye image data frame to a head-mounted display of the virtual reality device.

The host may, by a wired transmission channel, such as HDMI, Display Port and USB Type-C, send the difference encoded information and the left eye image data frame to the head-mounted display. Alternatively, the host may, by a wireless transmission channel, such as by using the wave band of 60 GHz millimeter wave, wirelessly send the difference encoded information and the left eye image data frame to the head-mounted display.

Understandably, the present embodiment is not limit to that the host can only transmit the difference encoded information and the left eye image data frame, but it can also transmit the difference encoded information and the right eye image data frame. The present embodiment illustratively describes the example of transmitting the difference encoded information and the left eye image data frame is merely in order to facilitate the description. In order to facilitate the description, all of the following embodiments of the present application will describe the example that the host sends the difference encoded information and the left eye image data frame to the head-mounted display of the virtual reality device.

In the present embodiment, the host of the virtual reality device calculates the difference between the left eye image data frame and the corresponding right eye image data frame that are to be transmitted, to obtain difference information between the two eye image data frames. The method does not need to conduct inter-frame redundant information movement estimation of high complexity, and can obtain the difference information between the two eye image data frames by using simple subtraction calculations. By conducting compressed encoding on the difference information by using simple encoding rules, the host only needs to transmit the difference encoded information and the image data frame of one eye, which reduces the bandwidth occupied by the transmission of image data, further reduces the delay, and improves the user experience.

The present embodiment can reduce the transmission bandwidth of the image data and increase the transmission efficiency of the image data between the host and the head-mounted display of the virtual reality device by increasing the compression ratio while ensuring a low delay.

FIG. 2 is a flow chart of a method for processing image data applied to a head-mounted display according to an embodiment of the present disclosure. The processing method is applied to a head-mounted display of a virtual reality device, and the method of the present embodiment is particularly suitable for a head-mounted display that conducts data transmission with a host of the virtual reality device wirelessly. As shown in FIG. 2, the method for processing image data of the present embodiment comprises:

S210, receiving difference encoded information and a left eye image data frame that are sent by the host of the virtual reality device, wherein the difference encoded information is obtained by conducting compressed encoding by using a preset encoding rule with respect to difference information between the left eye image data frame and the right eye image data frame that are to be transmitted.

S220, decompressing the difference encoded information according to a preset decoding rule, to obtain the difference information.

The preset decoding rule coincides with the preset encoding rule in the present embodiment, and if the host uses run-length encoding rule to conduct compressed encoding on the difference information, the head-mounted display uses the corresponding run-length decoding rule to decompress the difference encoded information.

S230, obtaining the corresponding right eye image data frame according to the difference information and the received left eye image data frame.

Because the difference information of the present embodiment is obtained by calculating the difference between the left eye image data frame and the corresponding right eye image data frame, this step may, correspondingly, add up the left eye image data frame and the difference information to obtain the right eye image data frame.

Exemplarily, when calculating the difference between corresponding pixel values in the left eye image data frame and corresponding pixel values in the right eye image data frame to obtain the difference information, this step is particularly: adding up the corresponding pixel values between the left eye image data frame and the difference information, to obtain the right eye image data frame.

S240, displaying the left eye image data frame and the right eye image data frame.

The head-mounted display of the present embodiment decodes the difference encoded information sent by the host to obtain the difference information, can construct the right eye image data frame by conducting simple addition operations with respect to the difference information and the received left eye image data frame, and can output and display the image data after the right eye image data frame is completely constructed. The head-mounted display only needs to conduct simple decoding processing and addition operation with respect to the received data, so the calculating complexity is low, and the required processing duration is very short. Therefore, the present disclosure can reduce the delay of the data display, and improve the user experience.

Correspondingly to the embodiment of the above method for processing image data, the present disclosure further provides a device for processing image data.

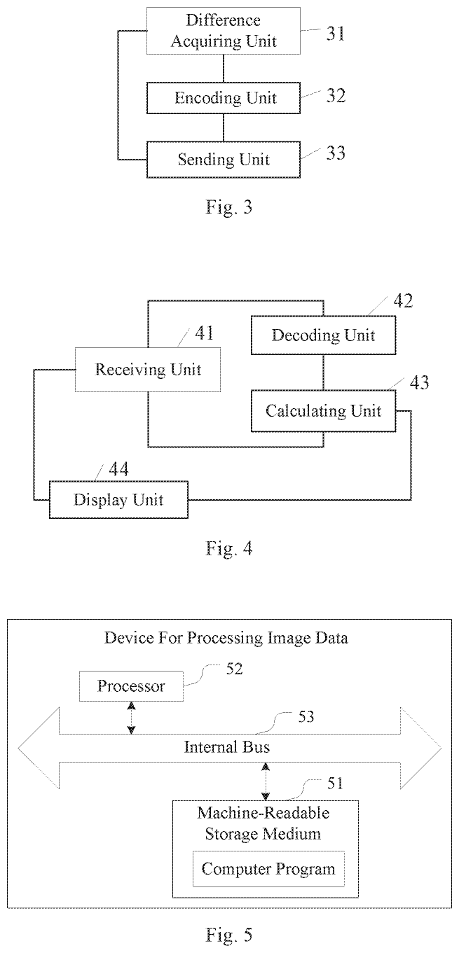

FIG. 3 is a functional block diagram of a device for processing image data applied to a sending end of a host according to an embodiment of the present disclosure. The processing device is applied to a host of a virtual reality device, and is particularly suitable for a host that conducts data transmission with a head-mounted display wirelessly.

As shown in FIG. 3, the device for processing image data of the present embodiment comprises: a difference acquiring unit 31, an encoding unit 32 and a sending unit 33.

The difference acquiring unit 31 is configured to acquire a left eye image data frame and a corresponding right eye image data frame that are to be transmitted, and calculate a difference between the acquired left eye image data frame and corresponding right eye image data frame, to obtain difference information between the two eye image data frames.

Exemplarily, the difference acquiring unit 31 is particularly configured to calculate a difference between corresponding pixel values in the left eye image data frame and the right eye image data frame, to obtain difference information between the two eye image data frames.

The encoding unit 32 is configured to conduct compressed encoding on the difference information by using a preset encoding rule, to obtain compressed difference encoded information.

Exemplarily, the encoding unit 32 utilizes simpler compressed encoding methods, such as run-length encoding or entropy encoding rules, to conduct compressed encoding on the difference information, to quickly compress and decompress the difference information, so that the delay generated by the compressing and decompressing processes can be neglected.

The sending unit 33 is configured to send the difference encoded information and the left eye image data frame to a head-mounted display of the virtual reality device.

In the present embodiment, the host of the virtual reality device calculates the difference between the left eye image data frame and the corresponding right eye image data frame that are to be transmitted, to obtain difference information between the two eye image data frames. The method does not need to conduct inter-frame redundant information movement estimation of high complexity, and can obtain the difference information between the two eye image data frames by using simple subtraction calculations. By conducting compressed encoding on the difference information by using simple encoding rules, the host only needs to transmit the difference encoded information and the image data frame of one eye, which reduces the bandwidth occupied by the transmission of image data, further reduces the delay, and improves the user experience.

FIG. 4 is a functional block diagram of a device for processing image data applied to a head-mounted display according to an embodiment of the present disclosure. The processing device is applied to a head-mounted display of a virtual reality device, and is particularly suitable for a head-mounted display that conducts data transmission with a host wirelessly.

As shown in FIG. 4, the device for processing image data of the present embodiment comprises: a receiving unit 41, a decoding unit 42, a calculating unit 43 and a display unit 44.

The receiving unit 41 is configured to receive difference encoded information and a left eye image data frame that are sent by a host of the virtual reality device, wherein the difference encoded information is obtained by conducting compressed encoding by using a preset encoding rule with respect to difference information between the left eye image data frame and the right eye image data frame that are to be transmitted.

The decoding unit 42 is configured to decompress the difference encoded information according to a preset decoding rule, to obtain the difference information; wherein the preset decoding rule and the preset encoding rule are corresponding.

The calculating unit 43 is configured to obtain the corresponding right eye image data frame according to the difference information and the received left eye image data frame.

Exemplarily, the calculating unit 43 is particularly configured to add up the left eye image data frame and the difference information, to obtain the right eye image data frame.

The display unit 44 is configured to display the left eye image data frame and the right eye image data frame.

The head-mounted display of the present embodiment decodes the difference encoded information sent by the host to obtain the difference information, can construct the right eye image data frame by conducting simple addition operations with respect to the difference information and the received left eye image data frame, and can output and display the image data after the right eye image data frame is completely constructed. The head-mounted display only needs to conduct simple decoding processing and addition operation with respect to the received data, so the calculating complexity is low, and the required processing duration is very short. Therefore, the present disclosure can reduce the delay of the data display, and improve the user experience.

Correspondingly to the above embodiment of the method for processing image data, the present disclosure further provides a device for processing image data.

FIG. 5 is a structural block diagram of a device for processing image data applied to a sending end of a host according to an embodiment of the present disclosure. As shown in FIG. 5, the device for processing image data comprises a machine-readable storage medium 51 and a processor 52 that are communicatively connected by an internal bus 53, the machine-readable storage medium 51 stores a computer program executable by the processor 52, and when executed by the processor 52 the computer program implements the following steps:

acquiring a left eye image data frame and a corresponding right eye image data frame that are to be transmitted, and calculating a difference between the acquired left eye image data frame and corresponding right eye image data frame, to obtain difference information between the two eye image data frames;

conducting compressed encoding on the difference information by using a preset encoding rule, to obtain compressed difference encoded information; and

sending the difference encoded information and the left eye image data frame to a head-mounted display of the virtual reality device; or, sending the difference encoded information and the right eye image data frame to a head-mounted display of the virtual reality device.

Optionally, the step of calculating a difference between the acquired left eye image data frame and corresponding right eye image data frame comprises: calculating a difference between corresponding pixel values in the left eye image data frame and corresponding pixel values in the right eye image data frame, to obtain difference information between the two eye image data frames.

Optionally, the step of conducting compressed encoding on the difference information by using a preset encoding rule comprises: conducting compressed encoding on the difference information by using a run-length encoding rule or an entropy encoding rule.

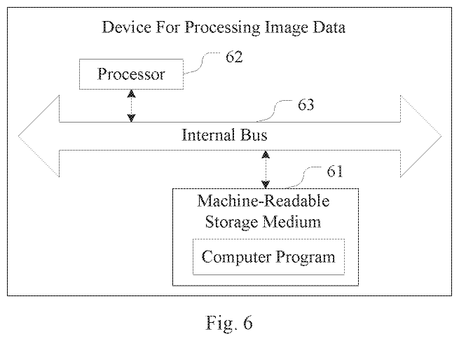

FIG. 6 is a structural block diagram of a device for processing image data applied to a head-mounted display according to an embodiment of the present disclosure. As shown in FIG. 6, the device for processing image data comprises a machine-readable storage medium 61 and a processor 62 that are communicatively connected by an internal bus 63, the machine-readable storage medium 61 stores a computer program executable by the processor 62, and when executed by the processor 62 the computer program implements the following steps:

receiving difference encoded information and a left eye image data frame that are sent by a host of the virtual reality device, or, receiving difference encoded information and a right eye image data frame that are sent by a host of the virtual reality device; wherein the difference encoded information is obtained by conducting compressed encoding by using a preset encoding rule on difference information between the left eye image data frame and the right eye image data frame that are to be transmitted;

decompressing the difference encoded information according to a preset decoding rule, to obtain the difference information;

obtaining the corresponding right eye image data frame according to the difference information and the received left eye image data frame, or, obtaining the corresponding left eye image data frame according to the difference information and the received right eye image data frame; and

displaying the left eye image data frame and the right eye image data frame.

Optionally, the difference information is obtained by calculating a difference between corresponding pixel values in the left eye image data frame and the right eye image data frame.

Optionally, the step of obtaining the corresponding right eye image data frame according to the difference information and the received left eye image data frame comprises: adding up the corresponding pixel values between the left eye image data frame and the difference information, to obtain the right eye image data frame.

In different embodiments, the machine-readable storage media 51, 61 may be a random access memory or a nonvolatile memory. The nonvolatile memory may be a storage drive (such as hard disk drive), a solid state disk, any type of memory discs (such as optical disc and DVD), or similar storage media, or a combination thereof. The random access memory may be an RAM (Radom Access Memory), a volatile memory, a nonvolatile memory and a flash memory. Further, the nonvolatile memory and the random access memory, as the machine-readable storage medium, can store the computer program executed by the processors 52, 62.

It should be noted that, the device for processing image data of the present embodiment is corresponding to the above method for processing image data, so the parts of the device for processing image data of the present embodiment that are not described can refer to related description of the method for processing image data of the above embodiment of the present disclosure, and are not further described here.

In conclusion, in the technical solutions of the present disclosure, the host of the virtual reality device calculates the difference between the left eye image data frame and the corresponding right eye image data frame that are to be transmitted, to obtain difference information between the two eye image data frames. The method does not need to conduct inter-frame redundant information movement estimation of high complexity, and can obtain the difference information between the two eye image data frames by using simple subtraction calculations. By conducting compressed encoding on the difference information by using simple encoding rules, the host only needs to transmit the difference encoded information and the image data frame of one eye, which reduces the bandwidth occupied by the transmission of image data, and further reduces the delay. In the technical solutions of the present disclosure, the head-mounted display decodes the difference encoded information sent by the host to obtain the difference information, can construct the other eye image data frame by conducting simple addition operations with respect to the difference information and the received left eye image data frame, and can output and display the image data after the image data frame is completely constructed. The head-mounted display only needs to conduct simple decoding processing and addition operation to the received data, so the calculating complexity is low, and the required processing duration is very short. Therefore, the present disclosure can reduce the delay of the data display, and improve the user experience.

The above merely describes particular embodiments of the present disclosure. By the teaching of the present disclosure, a person skilled in the art can make other modifications or variations on the basis of the above embodiments. A person skilled in the art should appreciate that, the above detailed description is only for the purpose of better explaining the present disclosure, and the protection scope of the present disclosure should be subject to the protection scope of the claims.

1. A method for processing image data, applied to a host of a virtual reality device, wherein the method comprises:
acquiring a left eye image data frame and a corresponding right eye image data frame that are to be transmitted, and calculating a difference between the acquired left eye image data frame and corresponding right eye image data frame, to obtain difference information between the two eye image data frames;
conducting compressed encoding on the difference information by using a preset encoding rule, to obtain compressed difference encoded information; and
sending the difference encoded information and the left eye image data frame to a head-mounted display of the virtual reality device; or, sending the difference encoded information and the right eye image data frame to a head-mounted display of the virtual reality device.

2. The method for processing image data according to claim 1, wherein the step of calculating a difference between the acquired left eye image data frame and corresponding right eye image data frame comprises:
calculating a difference between corresponding pixel values in the left eye image data frame and the right eye image data frame, to obtain difference information between the two eye image data frames.

3. The method for processing image data according to claim 1, wherein the step of conducting compressed encoding on the difference information by using a preset encoding rule comprises:
conducting compressed encoding on the difference information by using a run-length encoding rule or an entropy encoding rule.

4. A method for processing image data, applied to a head-mounted display of a virtual reality device, wherein the method comprises:
receiving difference encoded information and a left eye image data frame that are sent by a host of the virtual reality device, or, receiving difference encoded information and a right eye image data frame that are sent by a host of the virtual reality device; wherein the difference encoded information is obtained by conducting compressed encoding by using a preset encoding rule on difference information between the left eye image data frame and the right eye image data frame that are to be transmitted;
decompressing the difference encoded information according to a preset decoding rule, to obtain the difference information;
obtaining the corresponding right eye image data frame according to the difference information and the received left eye image data frame, or, obtaining the corresponding left eye image data frame according to the difference information and the received right eye image data frame; and
displaying the left eye image data frame and the right eye image data frame.

5. The method for processing image data according to claim 4, wherein the difference information is obtained by calculating a difference between corresponding pixel values in the left eye image data frame and the right eye image data frame.

6. The method for processing image data according to claim 5, wherein the step of obtaining the corresponding right eye image data frame according to the difference information and the received left eye image data frame comprises:
adding up the corresponding pixel values between the left eye image data frame and the difference information, to obtain the right eye image data frame.

7-12. (canceled)

13. A device for processing image data, applied to a host of a virtual reality device, wherein the device comprises a machine-readable storage medium and a processor that are communicatively connected by an internal bus, the machine-readable storage medium stores a computer program executable by the processor, and when executed by the processor the computer program implements the steps as following:
acquiring a left eye image data frame and a corresponding right eye image data frame that are to be transmitted, and calculating a difference between the acquired left eye image data frame and corresponding right eye image data frame, to obtain difference information between the two eye image data frames;
conducting compressed encoding on the difference information by using a preset encoding rule, to obtain compressed difference encoded information; and
sending the difference encoded information and the left eye image data frame to a head-mounted display of the virtual reality device; or, sending the difference encoded information and the right eye image data frame to a head-mounted display of the virtual reality device.

14. A device for processing image data, applied to a head-mounted display of a virtual reality device, wherein the device comprises a machine-readable storage medium and a processor that are communicatively connected by an internal bus, the machine-readable storage medium stores a computer program executable by the processor, and when executed by the processor the computer program implements the steps as following:
receiving difference encoded information and a left eye image data frame that are sent by a host of the virtual reality device, or, receiving difference encoded information and a right eye image data frame that are sent by a host of the virtual reality device; wherein the difference encoded information is obtained by conducting compressed encoding by using a preset encoding rule on difference information between the left eye image data frame and the right eye image data frame that are to be transmitted;
decompressing the difference encoded information according to a preset decoding rule, to obtain the difference information;
obtaining the corresponding right eye image data frame according to the difference information and the received left eye image data frame, or, obtaining the corresponding left eye image data frame according to the difference information and the received right eye image data frame;and
displaying the left eye image data frame and the right eye image data frame.

15. The device for processing image data according to claim 14, wherein the difference information is obtained by calculating a difference between corresponding pixel values in the left eye image data frame and the right eye image data frame.

16. The device for processing image data according to claim 15, wherein the step of obtaining the corresponding right eye image data frame according to the difference information and the received left eye image data frame comprises:
adding up the corresponding pixel values between the left eye image data frame and the difference information, to obtain the right eye image data frame.

17. The device for processing image data according to claim 13, wherein the step of calculating a difference between the acquired left eye image data frame and corresponding right eye image data frame comprises:
calculating a difference between corresponding pixel values in the left eye image data frame and the right eye image data frame, to obtain difference information between the two eye image data frames.

18. The device for processing image data according to claim 13, wherein the step of conducting compressed encoding on the difference information by using a preset encoding rule comprises:
conducting compressed encoding on the difference information by using a run-length encoding rule or an entropy encoding rule.
